(19) United States
(12) Patent Application Publication
(10) Pub. No.: US 2014/0011916 A1
(43) Pub. Date: Jan. 9, 2014

(54) THERMALLY CURABLE RESIN COMPOSITION WITH GOOD COATABILITY AND RE-COATABILITY

(71) Applicants: Seung-Hee Lee, Seoul (KR); Sang-Kyu Kwak, Daejeon (KR); Mi-Ae Kim, Daejeon (KR); Sung-Hyun Kim, Daejeon (KR); Jong-Hwi Hwang, Seoul (KR); Beom-Su Park, Daejeon (KR)

(72) Inventors: Seung-Hee Lee, Seoul (KR); Sang-Kyu Kwak, Daejeon (KR); Mi-Ae Kim, Daejeon (KR); Sung-Hyun Kim, Daejeon (KR); Jong-Hwi Hwang, Seoul (KR); Beom-Su Park, Daejeon (KR)

(73) Assignee: LG CHEM, LTD., Seoul (KR)

(21) Appl. No.: 13/811,606

(22) PCT Filed: Jul. 19, 2011
(86) PCT No.: PCT/KR11/05283

§ 371 Date: Sep. 26, 2013

(30) Foreign Application Priority Data
Jul. 19, 2010 (KR) 10-2010-0069557

(51) Int. Cl. C08L 63/00

(52) U.S. Cl. CPC C08L 63/00
USPC 523/400; 526/273

(57) ABSTRACT

The present invention relates to a thermally curable binder resin including an epoxy group-containing ethylenic unsaturated monomer and an aqueous monomer including an ethylene oxide group; or an epoxy group-containing ethylenic unsaturated monomer, a compound including an acidic component, and an aqueous monomer including an ethylene oxide group, a thermally curable resin composition including the same, a cured film prepared therefrom, a color filter, and a liquid crystal display device. The thermally curable binder resin of the present invention may significantly enhance the coatability of a cured film forming composition and increase the surface energy of a coated protective film to significantly enhance the recoating properties in subsequent processes after formation of the protective film.

### TECHNICAL FIELD

The present invention disclosed herein relates to a thermally curable resin composition for color filter protective film for LCD, and more particularly, to a thermally curable resin which may form a cured film with various good chemical resistances such as heat resistance, acid resistance, alkali resistance, etc., good coatability to a substrate, and good recoating properties for subsequent processes, a cured film formed by using the composition, and a liquid crystal display device including the film.

### BACKGROUND ART

A color liquid crystal display device is treated with a solvent, an acid solution, or an alkali solution during preparation processes thereof, or the surface of the device is partially treated at a high temperature upon formation of a transparent electrode layer through a sputtering process. Occasionally, when the transparent electrode layer is etched to a desired shape, the above device is exposed to an acid solution or an alkali solution under severe conditions. In order to prevent damage to pixels due to heat or chemical material upon such treatment, a protective film, which consists of a thin film resistant to the above treatment, is formed. Along with the trend of enlarging display devices such as liquid crystal displays (LCDs), the size of a substrate used is also being increasing. Currently, production lines for the 8th generation substrates have been installed, and as substrates are getting larger, the coating method which is applicable when a photoresist composition is coated is also being changed.

Although a coating method called slit and spin, which is spinning after a photoresist composition, etc, is applied on a substrate through a slit, was used on the 4th generation size glass substrate, a spinless coating method to which only the application process is used without performing the spinning process has been employed because it is difficult to perform the spin itself on the 5th generation or more substrate with a size of 1000 mm×1000 mm or more. The spinless coating is a method of applying a coating composition on a large substrate by spraying the coating composition through a nozzle and scanning in a certain direction.

When the spin coating method is used in a conventional manner, it is possible to obtain a coating with a uniform thickness, but a large amount of a composition solution used for spin coating is consumed and there is a limitation in spinning a large area. On the contrary, in the spinless coating method, the viscosity of a coating solution is decreased in order to ensure the thickness uniformity within a substrate, compared to a related-art spin coating method, and thus the overall solid content is decreased and the solvent content is increased to show a tendency to be more vulnerable to coatability and spots. The change in coating solution composition used due to a change in coating method along with a large area of the substrate is also essential. Although there is a method of increasing the input of a surfactant in constituting components of the composition in order to ensure the applicability, there is a considerable limitation in the input because recoating properties may be problematic in the subsequent processes.

Therefore, it is necessary to develop a composition which may ensure the coatability in a composition with the same surface tension. In addition, when the spinless coating method is applied to a large area substrate, a coating film formed with a coating solution composition should be uniform and there should not be stains on the coating film.

Since display devices such as in-plane switching (IPS) mode liquid crystal devices, etc. should not have variations in thickness in order to make a uniform liquid crystal to be filled uniform and it is important to maintain the cell gap, a protective film with good planarizability is needed.

Although a fluorine-based or silicon-based surfactant with a high surface tension lowering effect was generally used in order to ensure the coatability and planarizability in the related art, it is disadvantageous in that the surface energy has been significantly reduced after a paint film obtained during the addition of an excess of the surfactant is cured to deteriorate the recoating properties in subsequent processes, and its use is limited because bubbles generated in pipes during the process are responsible for various defects. Above all, there are cases in which surfactants are not effective according to the kind of a polymer constituting a material.

The coatability of a composition for forming an protective film (overcoat, OC) and the recoating property in subsequent processes after formation of the protective film are a trade-off relationship, and thus it is required that the technology which may enhance the two properties at the same time is developed.

### DETAILED DESCRIPTION OF INVENTION

### Technical Problem

In order to solve the coatability and recoating property of a thermally curable composition for a protective film used in a color filter of the liquid crystal display device, the present invention provides a thermally curable binder resin which may enhance the coatability of a thermally curable composition and increase its surface energy to provide a cured film with the subsequent processability (coatability) improved.

The present invention also provides a thermally curable resin composition including the thermally curable binder resin, a cured film formed by using the same, and a color filter and a liquid crystal display device including the cured film.

### Technical Solution

In the present invention, a thermally curable binder resin including an epoxy group-containing ethylenic unsaturated monomer and an aqueous monomer including an ethylene oxide group or including an epoxy group-containing ethylenic unsaturated monomer, a compound including an acidic component, and an aqueous monomer including an ethylene oxide group is used to enhance the affinity of the ethylene oxide group included in the thermally curable binder resin for a substrate and allow the edge portion of the color filter (bottom film), constituting a bare glass substrate to be well-coated, improving the coatability. In addition, even when a surfactant with a high surface tension lowering effect is used due to a higher surface energy after the formation of a film than that of a general resin, the subsequent processability is facilitated. Thus, various problems in the related art may be solved.

### Effects of Invention

According to the present invention, a relatively small amount of a surfactant may be added to a low-viscosity material to ensure the coatability of a protective film, and the subsequent processability (recoating property) is facilitated due to high surface energy after the formation of a film even when a surfactant with a high surface tension lowering effect is used.

### BEST MODE FOR INVENTION

A thermally curable binder resin according to the present invention includes an epoxy group-containing ethylenic unsaturated monomer and an aqueous monomer including an ethylene oxide group.

In addition, another thermally curable binder resin according to the present invention includes an epoxy group-containing ethylenic unsaturated monomer; a compound including an acidic component; and an aqueous monomer including an ethylene oxide group.

Hereinafter, the present invention will be described in more detail as follows.

<Thermally Curable Binder Resin>

A thermally curable binder resin (A-1) according to the present invention includes an epoxy group-containing ethylenic unsaturated monomer (a-1) and an aqueous monomer including an ethylene oxide group (b-1).

In addition, a thermally curable binder resin (A-2) according to the present invention includes an epoxy group-containing ethylenic unsaturated monomer (a-1); an aqueous monomer including an ethylene oxide group (b-1); and a compound including an acidic component (c-1).

That is, A-1 as a thermally curable binder resin according to the present invention includes an epoxy group-containing ethylenic unsaturated monomer (a-1) and an aqueous monomer including an ethylene oxide group (b-1), and it is desirable to add a separate curing agent subsequently to a thermally curable resin composition in order to cure the epoxy group-containing ethylenic unsaturated monomer.

In addition, A-2 as a thermally curable binder resin according to the present invention includes an epoxy group-containing ethylenic unsaturated monomer (a-1) and an aqueous monomer including an ethylene oxide group (b-1), and a compound including an acidic component (c-1) for curing the epoxy group-containing ethylenic unsaturated monomer (a-1) in the thermally curable binder resin.

The epoxy group-containing ethylenic unsaturated monomer (a-1) constituting the thermally curable binder resin according to the present invention is not particularly limited as long as it is a compound having an ethylenic unsaturated bond which is radical polymerizable in a molecule and an epoxy group together. However, it is desirable to use an uncolored compound because it should have excellent transparency to be used as a color filter protective film for LCD. Specifically, it is one or more selected from the group consisting of an aliphatic epoxy group-containing unsaturated monomer, a cycloaliphatic epoxy group-containing unsaturated monomer, and an aromatic epoxy-containing unsaturated monomer.

Specific examples thereof is one or more selected from the group consisting of allyl glycidyl ether, glycidyl 5-norbornene-2-methyl-2-carboxylate (endo and exo mixtures), 1,2-epoxy-5-hexene, 1,2-epoxy-9-decene, 3,4-glycidyl(meth)acrylate, glycidyl α-ethyl(meth)acrylate, glycidyl α-n-propyl(meth)acrylate, glycidyl α-n-butyl(meth)acrylate, 3,4-epoxybutyl(meth)acrylate, 4,5-epoxypentyl(meth)acrylate, 5,6-epoxyheptyl(meth)acrylate, 6,7-epoxyheptyl α-ethylacrylate, methylglycidyl(meth)acrylate; and compounds represented by the following Formulas 1 to 3, but it is not limited thereto.

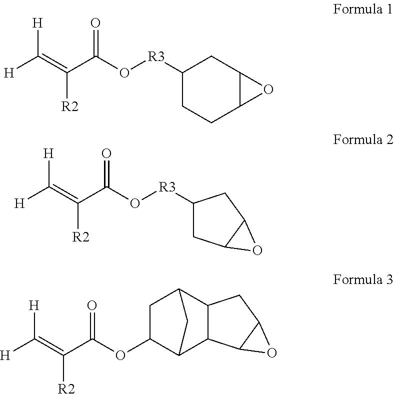

In Formulas 1 to 3, R2 is a hydrogen atom or a C1 to C6 alkyl group, and R3 is a C1 to C6 alkylene.

The R2 alkyl group may be a linear or branched one, and a specific example thereof is one selected from the group consisting of a methyl group, an ethyl group, a propyl group, an isopropyl group, an n-butyl group, an iso-butyl group, a sec-butyl group, and an n-pentyl group.

In addition, the alkylene group may be a linear or branched one, and a specific example thereof is one selected from the group consisting of a methylene group, an ethylene group, a propylene group, an isopropylene group, an n-butylene group, an iso-butylene group, a sec-butylene group, and an n-pentylene group.

The epoxy group-containing ethylenic unsaturated monomer (a-1) is included in an amount of 10 to 90% by weight based on the weight of the thermally curable binder resin (A-1, A-2), preferably 15 to 85% by weight, and more preferably 20 to 70% by weight. When the monomer (a-1) is included in an amount of less than 10% by weight, a desired level of curing may not be sufficiently reached and thus adverse effects may be easily caused on mechanical strength, chemical resistance, and heat resistance of a cured film formed. When the monomer (a-1) is included in an amount of more than 90% by weight, other monomers (b-1, c-1) are included in relatively small amounts to tend to reach an insufficient level of curing.

In addition, the aqueous monomer including an ethylene oxide group (b-1) constituting the thermally curable binder resin A-1, A-2 of the present invention is represented by the following Formula 4.

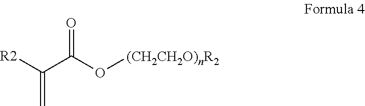

In the Formula, R1 is a hydrogen atom or a C1 to C5 alkyl group; n is 1 to 9; and R2 is a hydrogen atom or a C1 to C4 alkyl group.

The alkyl group may be a linear or branched one, and a specific example thereof is one selected from the group consisting of a methyl group, an ethyl group, a propyl group, an isopropyl group, an n-butyl group, an iso-butyl group, a sec-butyl group, and an n-pentyl group.

The aqueous monomer including the ethylene oxide group (b-1) represented by Formula 4 serves to enhance the affinity for a substrate to improve the coatability. That is, an edges of a color filter (bottom film) constituting a bare glass may be coated well by the glass affinity. In addition, the monomer (b-1) is an aqueous monomer, and the coatability of a protective film may be ensured only by adding a relatively small amount of a surfactant in a spinless material which is important in securing the coatability, the stain control, and the uniformity of the film. In addition, even when a surfactant with a high surface tension lowering effect is used due to a higher surface energy after the formation of a film than that of a general resin, it is advantageous in that the subsequent processability is facilitated.

Specific examples of the monomer (b-1) according to the present invention may include methoxydiethyleneglycol monomethacrylate or methoxytriethyleneglycol monomethacrylate, or a (meth)acrylate monomer having a hydroxyl group instead of an alkoxy group in the same structure.

The aqueous monomer including an ethylene oxide group (b-1) may be included in an amount of 1 to 40% by weight based on the weight of the thermally curable binder resin (A-1, A-2), preferably 3 to 35% by weight, and more preferably 5 to 35% by weight. When the monomer (b-1) is included in an amount of more than 40% by weight, heat resistant properties of a protective film tends to be deteriorated. However, the content of the monomer (b-1) included in a copolymer may be controlled according to the number of ethylene oxide group included in the monomer (b-1). In the composition of a thermally curable binder resin (A-1, A-2), effects of the present invention may be achieved even though a smaller amount of the monomer (b-1) is included when the monomer (b-1) including more ethylene oxide groups is used. Commercially available products that are appropriately used include M-20G, M-40G, M-90G, etc. from Shin-Nakamura Co. Ltd.

On the contrary, a thermally curable binder resin (A-2) according to the present invention includes a compound including an acidic component (c-1) for curing an epoxy group-containing ethylenic unsaturated monomer (a-1) in the resin, in addition to the monomers (a-1 and b-1).

The compound including an acidic component (c-1) may be an ethylenic unsaturated monomer including a compound including an acid group which is apparent to the structure as in an unsaturated carboxylic acid and/or an acid anhydride thereof; or including a latent acid group which is decomposed at 150□ or more to produce an acid.

Specific examples of the unsaturated carboxylic acid and/or the acid anhydride thereof include one or more selected from the group consisting of (meth)acrylic acid, crotonic acid, itaconic acid, maleic acid, fumaric acid, monomethyl maleic acid, isoprene sulfonic acid, styrene sulfonic acid, 5-norbornene-2-carboxylic acid, and an anhydride thereof, but they not limited thereto.

In addition, an ethylenic unsaturated monomer including a latent acid group in the compound (c-1) including the acid group is decomposed in a temperature range of preferably i50° C. to 250° C., at which a thermally curable resin composition of the present invention is subjected to post-bake, to produce an acid which may be reacted with an epoxy group in an epoxy group-containing ethylenic unsaturated monomer (a-1), and may be a monomer containing 2-tetrahydropyranyl group represented by the following Formula 5.

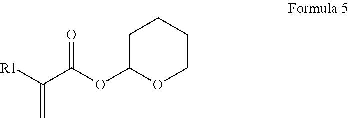

In the Formula, R1 is a hydrogen atom or a C1 to C5 alkyl group.

A compound including the acidic component (c-1) is suitably included in an amount of 5 to 60% by weight based on the weight of a thermally curable binder resin (A-2) of the present invention, preferably 5 to 50% by weight, and more preferably 5 to 45% by weight.

When the compound (c-1) is included in an amount of less than 5% by weight, a desired level of curing may not be sufficiently reached and thus adverse effects may be easily caused on mechanical strength, chemical resistance, and heat resistance of a cured film formed. When the compound (c-1) is included in an amount of more than 60% by weight, the preservation stability of a thermally curable binder resin and a thermally curable resin composition may be deteriorated.

In addition to the above-described monomers (a-1), (b-1), and (c-1) as components, a thermally curable binder resin (A-1, A-2) of the present invention may include one or more selected from the group consisting of an aliphatic or aromatic (meth)acrylate; a caprolactone modified (meth)acrylate; a (meth)acrylate having a hydroxyl group; a vinyl aromatic monomer; and a conjugated diene monomer, if necessary.

Specifically, the thermally curable binder resin includes aliphatic or aromatic(meth)acrylates such as benzyl(meth)acrylate, phenyl(meth)acrylate, cyclohexyl(meth)acrylate, methyl(meth)acrylate, ethyl(meth)acrylate, n-butyl(meth)acrylate, t-butyl(meth)acrylate, 2-ethylhexyl(meth)acrylate, etc.; caprolactone modified (meth)acrylate such as TONE M-100, TONE M-101, and TONE M-201 (products from DOW Chemical Company), FM-1, FM-2, and FM-3 (products from Daicel UCB Co. Ltd), etc.; 2-hydroxyethyl(meth)acrylate; styrene monomers such as styrene, 4-methoxystyrene, 4-methylstyrene, etc.; and conjugated diene-based compounds selected from 1,3-butadiene or isoprene, etc.

The monomers may be variously used in order to appropriately control physical properties of a cured paint film obtained from a thermally curable resin composition, such as mechanical strength, adhesion, planarizability, etc., and the monomer is present in an amount of preferably 1 to 50% by weight based on the weight of the binder resin (A1, A2) of the present invention.

A thermally curable binder resin A-2 according to the present invention may be easily cured by heating without any combination of a special curing agent because the presence of the monomers (a-1), (b-1), and (c-1) shows an activity when a thermally curable resin composition including the monomer is heated and cured.

However, a thermally curable binder resin A-1 according to the present invention may be cured by adding a separate curing agent to the following resin composition in combination of the monomers (a-1) and (b-1).

The thermally curable binder resin (A-1, A-2) of the present invention may be prepared by any one of various polymerization methods known in the art, such as solution polymerization, emulsion polymerization, etc., and one of a random copolymer, a block copolymer, etc., may be used. The molecular weight of a thermally curable binder resin (A-1, A-2) prepared by the method is not particularly limited as long as it may realize a planarized film, and may be suitably selected according to the film thickness of a film formed, the equipment for applying the composition, conditions and purposes for forming a film, etc. Specifically, the weight average molecular weight (Mw) is 2,000 to 100,000 in terms of polystyrene standards, and in particular, in a range of preferably 3,000 to 50,000. When the molecular weight is less than 2,000, the film performance of a thermally curable resin composition is easily deteriorated. When the molecular weight is more than 100,000, the binder resin may not be easily handled and the planarizability may be deteriorated. These effects may be confirmed with reference to Examples described below.

<Thermally Curable Resin Composition>

A thermally curable resin composition according to the present invention includes the thermally curable binder resin (A-1, A-2) and a solvent (B).

The thermally curable binder resin (A-1, A-2) is preferably included in an amount of 5 to 100% by weight based on the weight of the solid content of thermally curable resin composition in terms of securing coating properties and reliable physical properties after the formation of a film.

A solvent (B) is not particularly limited as long as it may dissolve constituting components uniformly and is so chemically stable that it does not react with components in the composition.

Non-limiting examples of the solvent (B) include alkyl ketones such as methylethylketone, cyclohexanone; ethers such as tetrahydrofuran; ethylene glycol alkyl ether acetates such as methyl cellosolve acetate, ethyl cellosolve acetate, ethylene glycol butyl ether acetate; propylene glycol alkyl ether acetates such as propylene glycol methyl ether acetate, propylene glycol ethyl ether acetate, propylene glycol propyl ether acetate; ethylene glycols such as butyl cellosolve, 2-methoxyethyl ether, ethylene glycol ethyl methyl ether, ethylene glycol diethyl ether; esters such as ethyl acetate, ethyl lactate, ethyl 3-ethoxypropionate; or a mixture thereof, etc.

The thermally curable resin composition according to the present invention may further include a curing agent. As above-mentioned, the thermally curable resin A-2 includes a compound including an acidic component (c-1) for curing the epoxy group-containing ethylenic unsaturated monomer (a-1) in the resin itself. On the contrary, the thermally curable resin A-1 does not include the compound (c-1) and thus the resin A-1 includes a curing agent for curing the epoxy group-containing ethylenic unsaturated monomer (a-1) in the thermally curable resin composition.

The curing agent may include acidic anhydrides such as phthalic anhydride, tetrahydrophthalic anhydride, hexa-hydrophthalic anhydride, methyltetrahydrophthalic anhydride, methylhexahydrophthalic anhydride, methyl endomethylene tetra-hydrophthalic anhydride, hexachloroendomethylene tetra-hydrophthalic anhydride, dodecyl succinic anhydride, and trimellitic anhydride, etc. Among them, trimellitic anhydride, which has high reactivity with and good compatibility with thermally curable binder resins, may be used. In addition, dianhydrides may include biphenyltetracarboxylic acid dianhydride, benzophenone tetracarboxylic acid dianhydride, propyl-2,2-diphenyl tetracarboxylic acid dianhydride, pyromellitic dianhydride, hexafluoropropylidene-2,2-diphenyl tetracarboxylic acid dianhydride, etc.

In the thermally curable resin composition according to the present invention, the thermally curable binder resin (A-1, A-2) and the solvent (B), which are mentioned above, as well as necessary additives (E), for example, polyfunctional monomers (C), surfactants, or thermal polymerization inhibitors, etc. may be used within the range of not affecting characteristics, such as planarizability, transmittance, heat resistance, etc. according to other use purposes, such as film performance, adhesion with a substrate, chemical stability, etc.

A compound with 2 to 6 unsaturated functional groups may be used as the polyfunctional monomer (C) having an ethylenic unsaturated bonding. This is due to the fact that each functional group connected to the central point may be cross-linked with another polyfunctional monomer to form a network structure and enhance the strength and chemical resistance of a cured film.

Non-limiting examples of the polyfunctional monomer (C) having an ethylenic unsaturated bonding may include polyfunctional(meth)acrylates such as ethyleneglycol di(meth)acrylate, propyleneglycol di(meth)acrylate, 1,3-butanediol di(meth)acrylate, neopentylglycol di(meth)acrylate, 1,6-hexanediol di(meth)acrylate, trimethylolpropane tri(meth)acrylate, pentaerythritol di(meth)acrylate, pentaerythritol tri(meth)acrylate, pentaerythritol tetra(meth)acrylate, dipentaerythritol penta(meth)acrylate, dipentaerythritol hexa(meth)acrylate, etc., and a compound selected from the above may be used alone or in a mixture thereof. In particular, dipentaerythritol pentaacrylate and dipentaerythritol hexaacrylate may be preferably used.

The polyfunctional monomer (C) having an ethylenic unsaturated bonding may be used in an amount of 1 to 200 parts by weight based on 100 parts of the thermally curable binder resin (A-1, A-2) of the present invention, and in particular, preferably 5 to 100 parts by weight. The polyfunctional monomer (C), which is a crosslinkable compound, is a molecule with a lower molecular weight than that of the thermally curable binder resin (A-1, A-2) and thus the monomer is effective in enhancing the planarizability. In particular, when the monomer is used in the composition range, the ability to form a paint film is excellent and the paint film is not sticky.

Other additives (E) may include components generally used in a coating solution, such as surfactants, thermal polymerization inhibitors, etc. A fluorine-based or silicon-based surfactant may be used as the surfactant.

In addition, the thermal polymerization inhibitor may include hydroquinone, 4-methoxyphenol, quinone, pyrocatechol, t-butyl catechol, phenothiazine, etc. The other additives (E) may be preferably used in an amount of 2 or less parts by weight based on 100 parts of the thermally curable binder resin (A-1, A-2). When the surfactant is used in the composition range, the generation of an excessive amount of bubbles may be prevented.

The solid content of the thermally curable resin composition may be appropriately selected according to the method of forming a film and the purpose, preferably to 60% by weight, and more preferably 5 to 40% by weight in particular in terms of coatability.

A cured film may be formed from the thermally curable resin composition according to the present invention by a typical method known in the art.

The cured film includes the thermally curable binder resin (A-1, A-2) according to the present invention, and the description thereof is as follows.

According to an embodiment of the following method of forming a cured film, a thermally curable resin composition solution is applied on a substrate by an appropriate method, and followed by prebake to remove the solvent and form an applied film, and followed by post bake to form a cured film.

The application method is not particularly limited. However, a spray method, a roll coating method, a spin coating method, a slit nozzle coating method, etc. may be used, and the spin coating method is generally used. In some cases, some of the residual solvent may be removed under reduced pressure before the prebake is performed after the application.

Conditions of the prebake are different from those of the post bake according to the composition used and its use purpose. For example, the prebake may be performed typically at 60° C. to 130° C. for 0.5 to 5 minutes. In addition, the post bake may be performed typically in a temperature range of 150° C. to 250° C. for 10 min to 2 hours.

Furthermore, each of the prebake and post bake may be performed in one step or a combination thereof. In the post bake step, an epoxy group in a thermally curable binder resin is reacted with an acid group decomposed to form a cured film with a network structure.

The surface energy of the cured film is in a range of 54 to 65 mN/m, and in particular, preferably 58 to 61 mN/m. Within the range, the subsequent processability is facilitated even when a surfactant with a high surface tension lowering effect is used.

In addition, the cured film is useful as a material for a color filter protective film because the film has excellent planarizability and high surface hardness as well as excellent heat resistance and various excellent chemical resistances such as acid resistance, alkali resistance, etc.

The present invention additionally provides a color filter including the protective film and a liquid crystal display device including the same. The liquid crystal display device includes a black matrix and a color filter, and may be manufactured by a typical method known in the art.

Hereinafter, the present invention will be described in more detail in Examples. However, the present invention is not limited thereto. Parts by weight in Examples are based on 100 parts by weight of a thermally curable binder resin.

### EXAMPLE 1

1-1. Thermally Curable Binder Resin

A monomer consisting of 15 parts by weight of 2-tetrahydropyranyl methacrylate, 40 parts by weight of glycidyl methacrylate, 20 parts by weight of methoxydiethyleneglycol monomethacrylate, and 25 parts by weight of styrene and 200 parts by weight of propyleneglycol methylether acetate as a solvent were each added to a flask with a nitrogen inlet, the flask was heated to 90° C., and 3.0 parts by weight of azobisvaleronitrile (AVN) were added to the flask to maintain the temperature for 9 hours. The reacted resin solution was dropped to an excess of hexane to form a precipitate and dried under vacuum to obtain a thermally curable binder resin (A1). The weight average molecular weight (Mw) of the resin (A1) in terms of polystyrene standards was 12,500.

1-2. Thermally Curable resin Composition

100 parts by weight of the synthesized copolymer (A1) were dissolved in 400 parts by weight of propyleneglycol methylether acetate as a solvent (B), 0.1 part by weight of a surfactant BYK307 (BYK) as another additive was mixed, the mixture was sufficiently stirred, and the resulting mixture was filtered with a filter having a pore diameter of 0.2 μm to obtain a thermally curable resin composition (P1).

1-3. Cured Film

After the thermally curable resin composition (P1) prepared in Example 1-2 was applied on a glass substrate by a spin coating method and a spinless coating method, a prebake was performed at 90° C. on a hot plate for 2 min, and subsequently a post bake was performed at 220° C. in a clean oven for 30 min to form a cured film (F1) with a thickness of 2.0 μm.

### EXAMPLE 2

Except that methoxytriethyleneglycol monomethacrylate was used instead of methoxydiethyleneglycol monomethacrylate, a process was performed in the same manner as in Example 1-1 to obtain a thermally curable binder resin (A2) with a weight average molecular weight (Mw) of 12,900 in terms of polystyrene standards. The resin (A2) was used and a process was performed in the same manner as in Examples 1-2 and 1-3 to prepare a composition and a cured film.

### EXAMPLE 3

Except that methoxyethyleneglycol monomethacrylate was used instead of methoxydiethyleneglycol monomethacrylate, a process was performed in the same manner as in Example 1-1 to obtain a thermally curable binder resin (A3) with a weight average molecular weight (Mw) of 12,000 in terms of polystyrene standards. The resin (A3) was used and a process was performed in the same manner as in Examples 1-2 and 1-3 to prepare a composition and a cured film.

### EXAMPLE 4

Except that 15 parts by weight of 2-tetrahydropyranyl methacrylate, 40 parts by weight of glycidyl methacrylate, parts by weight of methoxydiethyleneglycol monomethacrylate, and 35 parts by weight of styrene were used, a process was performed in the same manner as in Example 1-1 to obtain a thermally curable binder resin (A4) with a weight average molecular weight (Mw) of 11,500 in terms of polystyrene standards. The resin (A4) was used and a process was performed in the same manner as in Examples 1-2 and 1-3 to prepare a composition and a cured film.

### EXAMPLE 5

Except that 15 parts by weight of 2-tetrahydropyranyl methacrylate, 40 parts by weight of glycidyl methacrylate, 5 parts by weight of methoxyethyleneglycol monomethacrylate, and 35 parts by weight of styrene were used, a process was performed in the same manner as in Example 1-1 to obtain a thermally curable binder resin (A5) with a weight average molecular weight (Mw) of 12,200 in terms of polystyrene standards. The resin (A5) was used and a process was performed in the same manner as in Examples 1-2 and 1-3 to prepare a composition and a cured film.

### EXAMPLE 6

Except that methacrylic acid was used instead of 2-tetrahydropyranyl methacrylate, a process was performed in the same manner as in Example 1-1 to obtain a thermally curable binder resin (A6) with a weight average molecular weight (Mw) of 13,500 in terms of polystyrene standards. The resin (A6) was used and a process was performed in the same manner as in Examples 1-2 and 1-3 to prepare a composition and a cured film.

### EXAMPLE 7

Except that 50 parts by weight of glycidyl methacrylate, 30 parts by weight of styrene, and 20 parts by weight of methoxydiethyleneglycol monomethacrylate were used, a process was performed in the same manner as in Example 1-1 to obtain a thermally curable binder resin (A7) with a weight average molecular weight (Mw) of 13,200 in terms of polystyrene standards. In addition, 10 parts by weight of acid anhydride tri-mellitic anhydride as a curing agent were separately added to the mixture and a process was performed in the same manner as in Examples 1-2 to prepare a thermally curable resin composition. The composition was used and a process was performed in the same manner as in Example 1-3 to prepare a cured film.

### COMPARATIVE EXAMPLE 1

15 parts by weight of 2-tetrahydropyranyl methacrylate, 40 parts by weight of glycidyl methacrylate, and 45 parts by weight of styrene were used and a process was performed in the same manner as in Example 1-1 to obtain a binder copolymer resin with a weight average molecular weight (Mw) of 12,700 in terms of polystyrene standards. The copolymer was used and a process was performed in the same manner as in Examples 1-2 and 1-3 to prepare a thermally curable resin composition and a cured film.

### COMPARATIVE EXAMPLE 2

15 parts by weight of 2-tetrahydropyranyl methacrylate, 40 parts by weight of glycidyl methacrylate, 20 parts by weight of n-butyl methacrylate, and 25 parts by weight of styrene were used and a process was performed in the same manner as in Example 1-1 to obtain a binder copolymer resin with a weight average molecular weight (Mw) of 12,900 in terms of polystyrene standards. The copolymer was used and a process was performed in the same manner as in Examples 1-2 and 1-3 to prepare a thermally curable resin composition and a cured film.

### COMPARATIVE EXAMPLE 3

15 parts by weight of 2-tetrahydropyranyl methacrylate, 40 parts by weight of glycidyl methacrylate, 20 parts by weight of n-octyl methacrylate, and 25 parts by weight of styrene were used and a process was performed in the same manner as in Example 1-1 to obtain a binder copolymer resin with a weight average molecular weight (Mw) of 13,100 in terms of polystyrene standards. The copolymer was used and a process was performed in the same manner as in Examples 1-2 and 1-3 to prepare a thermally curable resin composition and a cured film.

### EXPERIMENTAL EXAMPLE 1

### Evaluation of Cured Films

In order to evaluate physical properties of a cured film formed by using a thermally curable resin composition of the present invention, the following experiment was performed.

Cured films (F1) prepared in Examples 1 to 7 were used, and cured films (F1) prepared in Comparative Examples 1 to 3 were used as control groups.

1-1. Protective Film (Overcoat, OC) Coatability

Each of the thermally curable resin compositions prepared in Examples 1 to 7 and Comparative Examples 1 to 3 was applied to a glass substrate through a spin coating method and a spinless coating method (TOK, TR45 spinless), respectively, and VCD and prebaking were performed to observe the overcoat solution being curled from the edge of a substrate for evaluation of the coatability. If the solution was observed not to be curled at all, it was recorded as fair (◯). If the solution was observed to be curled 10 mm or more from the edge, it was recorded as defective (X). The results are shown in the following Table 1.

1-2. Surface Energy of Overcoat Film

In order to confirm the subsequent processability of a cured film (F1) prepared, a surface energy was measured. Contact angles of DI water and CH₂I₂ were measured (KRUSS DSA100), and then surface energies obtained through the two contact angles are shown in Table 1.

1-3. Surface Hardness

A pencil hardness of the cured film (F1) was measured according to ASTM-D3363, and the results are shown in the following Table 1.

1-4. Adhesion

According to ASTM-D3359, 100 grids were formed on the cured film (F1) with a cutter knife by a grid tape method, and then the peeling off was performed with a tape. Then, the number of grid patterns which were peeled off among the 100 grid patterns was measured, and the adhesion was evaluated according to the following standard.

α: 5 or less in number of grid patterns peeled off

Δ: 6 to 49 in number of grid patterns peeled off

X: 50 or more in number of grid patterns peeled off

1-5. Transmittance

Glass substrates with a cured film (F1) formed thereon transmit light with a wavelength of 400 nm, respectively, and the results are shown in the following Table 1.

1-6. Acid Resistance

Glass substrates with a cured film (F1) formed thereon were immersed in an aqueous solution consisting of 5.0% by weight of HCl at 30° C. for 30 min, removed from the solution, and a change in appearance of the cured film (F1) was observed to evaluate the acid resistance. When there was no change in appearance, it was recorded as fair (◯). When the outer surface was peeled off or discolored into white, it was recorded as defective (X). The results are shown in the following Table 1.

1-7. Alkali Resistance

Glass substrates with a cured film (F1) formed thereon were immersed in an aqueous solution consisting of 5.0% by weight of NaOH at 30° C. for 30 min, removed from the solution, and a change in appearance of the cured film (F1) was observed to evaluate the alkali resistance. When there was no change in appearance, it was recorded as fair (◯). When the outer surface was peeled off or discolored into white, it was recorded as defective (X). The results are shown in the following Table 1.

1-8. Solvent Resistance

Glass substrates with a cured film (F1) formed thereon were immersed in an NMP solution at 40° C. for 10 min, a change in thickness of the cured film (F1) was observed to evaluate the solvent resistance. When the thickness change is within 3%, it was recorded as fair (◯). When the thickness change is more than 3%, it was recorded as defective (X). The results are shown in the following Table 1.

TABLE 1

| | Overcoat | | | | | | | | |
|---|---|---|---|---|---|---|---|---|---|
| | (OC) | | Surface | | | | Chemical | | |
| | coatability | | energy | | | | resistance | | |
| | Spin | Spinless | (mN/ | Surface | | | Acid | Alkali | Solvent |
| | coating | coating | m) | hardness | Adhesion | Transmittance | resistance | resistance | resistance |
| Example 1 | ◯ | ◯ | 60 | 4H | ◯ | >98% | ◯ | ◯ | ◯ |
| Example 2 | ◯ | ◯ | 61 | 4H | ◯ | >98% | ◯ | ◯ | ◯ |
| Example 3 | ◯ | ◯ | 60 | 4H | ◯ | >98% | ◯ | ◯ | ◯ |
| Example 4 | ◯ | ◯ | 58 | 4H | ◯ | >98% | ◯ | ◯ | ◯ |
| Example 5 | ◯ | Δ | 58 | 4H | ◯ | >98% | ◯ | ◯ | ◯ |
| Example 6 | ◯ | ◯ | 59 | 4H | ◯ | >98% | ◯ | ◯ | ◯ |
| Example 7 | ◯ | ◯ | 59 | 4H | ◯ | >98% | ◯ | ◯ | ◯ |
| Comparative | Δ | X | 51 | 4H | ◯ | >98% | ◯ | ◯ | ◯ |
| Example 1 | | | | | | | | | |
| Comparative | Δ | X | 50 | 4H | ◯ | >98% | ◯ | ◯ | ◯ |
| Example 2 | | | | | | | | | |
| Comparative | Δ | X | 50 | 4H | ◯ | >98% | ◯ | ◯ | ◯ |
| Example 3 | | | | | | | | | |

As shown from the results in Table 1, polymers including an aqueous monomer including an ethylene oxide group during the preparation of a thermally curable binder resin according to the present invention exhibited better results than those of polymers in Comparative Examples in terms of coatability, and the same effects were able to be obtained from both the spin coating method and the spinless method.

In addition, it was determined that compositions in Examples 1 to 7 of the present invention had surface energies higher than those of compositions in Comparative Examples 1 to 3. In general, the higher the surface energy of a film to be coated, the better the subsequent coatability of a coating material. It was confirmed that it had good recoating property due to the high surface energy.

1. A thermally curable binder resin, comprising as components:
an epoxy group-containing ethylenic unsaturated monomer; and
an aqueous monomer including an ethylene oxide group.

2. The resin of claim 1, wherein the thermally curable binder resin further comprises a compound including an acidic component.

3. The resin of claim 1, wherein the aqueous monomer including an ethylene oxide group is represented by the following Formula 4: 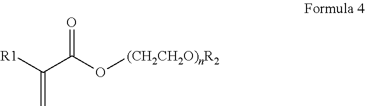
wherein R1 is H or a C1 to C5 alkyl group; n is 1 to 9; and R2 is H or a Cl to C4 alkyl group.

4. The resin of claim 2, wherein the compound including an acidic component is one or more selected from the group consisting of an unsaturated carboxylic acid, an unsaturated carboxylic acid anhydride, and an ethylenic unsaturated monomer including a latent acid group.

5. The resin of claim 4, wherein the ethylenic unsaturated monomer including a latent acid group is a compound which is decomposed in a range of 150° C. to 250° C. to produce an acid.

6. The resin of claim 5, wherein the compound is a 2-tetrahydropyranyl group-containing monomer represented by the following Formula 5: 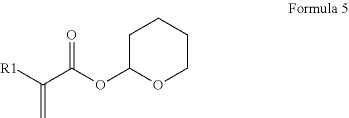
wherein R1 is a hydrogen atom or a C1 to C5 alkyl group.

7. The resin of claim 4, wherein the unsaturated carboxylic acid or unsaturated carboxylic acid anhydride is one or more selected from the group consisting of (meth)acrylic acid, crotonic acid, itaconic acid, maleic acid, fumaric acid, monomethyl maleic acid, isoprene sulfonic acid, styrene sulfonic acid, 5-norbornene-2-carboxylic acid, and an anhydride thereof.

8. The resin of claim 1, wherein the epoxy group-containing ethylenic unsaturated monomer is one or more selected from the group consisting of an aliphatic epoxy group-containing unsaturated monomer; a cycloaliphatic epoxy group-containing unsaturated monomer; and an aromatic epoxy-containing unsaturated monomer.

9. The resin of claim 8, wherein the epoxy group-containing ethylenic unsaturated monomer is one or more selected from the group consisting of allyl glycidyl ether, glycidyl 5-norbornene-2-methyl-2-carboxylate (endo and exo mixtures), 1,2-epoxy-5-hexene, 1,2-epoxy-9-decene, 3,4-glycidyl(meth)acrylate, glycidyl α-ethyl(meth)acrylate, glycidyl α-n-propyl(meth)acrylate, glycidyl α-n-butyl(meth)acrylate, 3,4-epoxybutyl(meth)acrylate, 4,5-epoxypentyl(meth)acrylate, 5,6-epoxyheptyl(meth)acrylate, 6,7-epoxyheptyl α-ethylacrylate, methylglycidyl(meth)acrylate, and a compound represented by the following Formulas 1 to 3: 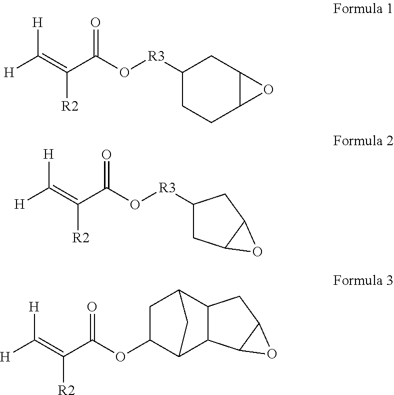
wherein R2 is a hydrogen atom or a C1 to C6 alkyl group, and R3 is a C1 to C6 alkylene.

10. The resin of claim 1, wherein the thermally curable binder resin comprises 10 to 90% by weight of an epoxy group-containing ethylenic unsaturated monomer and 1 to 40% by weight of an aqueous monomer including an ethylene oxide group.

11. The resin of claim 2, wherein the thermally curable binder resin comprises 10 to 90% by weight of an epoxy group-containing ethylenic unsaturated monomer; 5 to 60% by weight of a compound including an acidic component; and 1 to 40% by weight of an aqueous monomer including an ethylene oxide group.

12. The resin of claim 1, wherein the thermally curable binder resin further comprises one or more selected from the group consisting of an aliphatic or aromatic (meth)acrylate; a caprolactone modified (meth)acrylate; a (meth)acrylate having a hydroxyl group; a vinyl aromatic monomer; and a conjugated diene monomer.

13. The resin of claim 1, wherein the thermally curable binder resin has a weight average molecular weight (Mw) of 2,000 to 100,000.

14. A thermally curable resin composition comprising the thermally curable binder resin of claim 1.

15. The composition of claim 14, wherein the thermally curable binder resin is comprised in an amount of 5 to 100% by weight based on the weight of the solid content of the thermally curable resin composition.

16. The composition of claim 14, wherein the thermally curable resin composition further comprises one or more selected from the group consisting of a polyfunctional monomer having an ethylenic unsaturated bonding, a curing agent, a solvent, and other additives.

17. The composition of claim 16, wherein the curing agent is one or more selected from the group consisting of phthalic anhydride, tetrahydrophthalic anhydride, hexa-hydrophthalic anhydride, methyltetrahydrophthalic anhydride, methylhexahydrophthalic anhydride, methyl endomethylene tetra-hydrophthalic anhydride, hexachloroendomethylene tetra-hydrophthalic anhydride, dodecyl succinic anhydride, tri-mellitic anhydride, biphenyltetracarboxylic acid dianhydride, benzophenone tetracarboxylic acid dianhydride, propyl-2,2-diphenyl tetracarboxylic acid dianhydride, pyromellitic dianhydride, and hexafluoropropylidene-2,2-diphenyl tetracarboxylic acid dianhydride.

18. A cured film comprising a thermally curable binder resin, wherein the thermally curable binder resin comprises an epoxy group-containing ethylenic unsaturated monomer, a compound including an acidic component, and an ethylene oxide group.

19. The cured film of claim 18, wherein the cured film has a surface energy of 54 to 65 mN/m.

20. A protective film of a color filter using the cured film of claim 18.

21. A color filter comprising the protective film of claim 20.

22. A liquid crystal display device comprising the color filter of claim 21.
